(19) United States
(12) Patent Application Publication
(10) Pub. No.: US 2019/0022441 A1
(43) Pub. Date: Jan. 24, 2019

(54) PORTABLE FIRE DETECTION AND SUPPRESSION VEHICLE

(71) Applicant: Carrier Corporation, Jupiter, FL (US)

(72) Inventors: Subrahmanyam Konduri, Hyderabad (IN); Pratibha Kothakota, Hyderabad (IN); Nikhil Reddy Mudireddy, Hyderabad (IN)

(21) Appl. No.: 15/795,993

(22) Filed: Oct. 27, 2017

(30) Foreign Application Priority Data
Jul. 20, 2017 (IN) 201711025901

(51) Int. Cl. A62C 27/00; A62C 37/40; G05D 1/02

(52) U.S. Cl. CPC A62C 27/00; A62C 37/40; A62C 3/002; G05D 1/0227; G05D 1/0242; G05D 1/0278

(57) ABSTRACT

A portable fire detection and suppression vehicle is provided. The portable fire detection and suppression vehicle includes a fire suppression sub-system. The portable fire detection and suppression vehicle also includes sensors. The portable fire detection and suppression vehicle receives an input from a control panel of a facility or a central station and determines a location to automatically travel to within the facility. The portable fire detection and suppression vehicle utilizes the sensors to detect a condition of the facility and outputs feedback based on the condition to the control panel or the central station.

### CROSS-REFERENCE TO RELATED APPLICATIONS

This application claims priority to and the benefit of Indian Patent Application No. 201711025901 filed Jul. 20, 2017, and all the benefits accruing therefrom under U.S.C. § 119, the content of which is incorporated herein in its entirety by reference.

### BACKGROUND

In general, existing fire safety systems cater to all market segments and can be adapted to latest technology trends. However, contemporary deployment of suppression agents and emergency responsiveness face serious challenges, such as uncertainties during emergency conditions and integration with the existing fire safety systems.

### BRIEF DESCRIPTION

According to one or more embodiments, a portable fire detection and suppression vehicle is provided. The portable fire detection and suppression vehicle includes a fire suppression sub-system; and one or more sensors, wherein the portable fire detection and suppression vehicle receives an input from a control panel of a facility or a central station, determines a location to automatically travel to within the facility, utilizes the one or more sensors to detect a condition of the facility, and outputs feedback based on the condition to the control panel or the central station.

According to one or more embodiments or the above portable fire detection and suppression vehicle, the fire suppression sub-system can be utilized to suppress a fire within the facility upon arrival by the portable fire detection and suppression vehicle at the location.

According to one or more embodiments or any of the above portable fire detection and suppression vehicles, the fire suppression sub-system can receive instructions from the control panel or the central station in response to outputting the feedback.

According to one or more embodiments or any of the above portable fire detection and suppression vehicles, the fire suppression sub-system can travel to an access point of the facility in response to the input.

According to one or more embodiments or any of the above portable fire detection and suppression vehicles, the location can be an active zone within the facility and the portable fire detection and suppression vehicle can analyze a layout of facility and determines shortest path from the access point to the active zone.

According to one or more embodiments or any of the above portable fire detection and suppression vehicles, the fire suppression sub-system can analyze utilizes the one or more sensors to detect a fire source upon arrival at the active zone.

According to one or more embodiments or any of the above portable fire detection and suppression vehicles, the portable fire detection and suppression vehicle utilizes can process inputs received from one or more facility sensors within the facility.

According to one or more embodiments or any of the above portable fire detection and suppression vehicles, the portable fire detection and suppression vehicle can utilize comprises algorithms to dynamically prioritize multiple events at the facility, and the portable fire detection and suppression can attend to each of the multiple events based on the dynamic prioritization.

According to one or more embodiments or any of the above portable fire detection and suppression vehicles, the fire suppression sub-system can comprise a self-cooling sub-system employing one or more cooling mechanisms to counter extreme heat conditions that prevent suppression operations by the portable fire detection and suppression vehicle.

According to one or more embodiments, a fire detection and suppression system is provided. The fire detection and suppression system comprises a portable fire detection and suppression vehicle comprising: a fire suppression sub-system; and one or more sensors; and a control panel of a facility or a central station, wherein the portable fire detection and suppression vehicle receives an input from the control panel or the central station, determines a location to automatically travel to within the facility, utilizes the one or more sensors to detect a condition of the facility, and outputs feedback based on the condition to the control panel or the central station.

According to one or more embodiments or the above fire detection and suppression system, the fire suppression sub-system can be utilized to suppress a fire within the facility upon arrival by the portable fire detection and suppression vehicle at the location.

According to one or more embodiments or any of the above fire detection and suppression systems, the portable fire detection and suppression vehicle can receive instructions from the control panel or the central station in response to outputting the feedback.

According to one or more embodiments or any of the above fire detection and suppression systems, the portable fire detection and suppression vehicle can travel to an access point of the facility in response to the input.

According to one or more embodiments or any of the above fire detection and suppression systems, the location can be an active zone within the facility and the portable fire detection and suppression vehicle can analyze a layout of facility and determine shortest path from the access point to the active zone.

According to one or more embodiments or any of the above fire detection and suppression systems, the portable fire detection and suppression vehicle can utilize the one or more sensors to detect a fire source upon arrival at the active zone.

According to one or more embodiments or any of the above fire detection and suppression systems, the portable fire detection and suppression vehicle utilizes can process inputs received from one or more facility sensors within the facility.

According to one or more embodiments or any of the above fire detection and suppression systems, the portable fire detection and suppression vehicle can utilize comprises algorithms to dynamically prioritize multiple events at the facility, and the portable fire detection and suppression can attend to each of the multiple events based on the dynamic prioritization.

According to one or more embodiments or any of the above fire detection and suppression systems, the portable fire detection and suppression vehicle can comprise a self-cooling sub-system employing one or more cooling mechanisms to counter extreme heat conditions that prevent suppression operations by the portable fire detection and suppression vehicle.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

FIG. 1 depicts a fire detection and suppression system comprising a portable fire detection and suppression vehicle according to one or more embodiments;

FIG. 2 depicts a process flow with respect to a fire detection and suppression system according to one or more embodiments;

FIG. 3 depicts a fire detection and suppression system comprising a portable fire detection and suppression vehicle according to one or more embodiments; and

FIG. 4 depicts a process flow with respect to a fire detection and suppression system according to one or more embodiments.

### DETAILED DESCRIPTION

A detailed description of one or more embodiments of the disclosed apparatus and method are presented herein by way of exemplification and not limitation with reference to the FIGS.

Embodiments herein provide a robust and efficient fire detection and suppression system comprising a portable fire detection and suppression vehicle. The portable fire detection and suppression vehicle comprises a fire suppression sub-system for releasing gas and/or other agents in response to an automatic detection of a fire and/or remote control commands. The portable fire detection and suppression vehicle can also work with existing fire safety systems and overcome uncertainties during emergency conditions (without altering current installations of the existing fire safety systems).

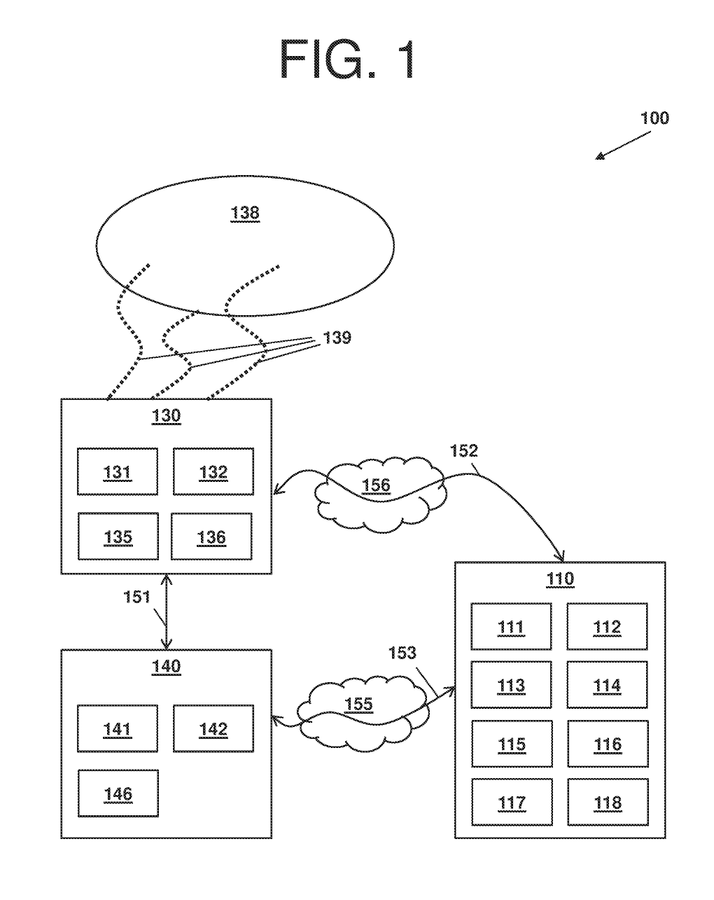

FIG. 1 depicts a fire detection and suppression system 100 comprising a portable fire detection and suppression vehicle 110 according to one or more embodiments. The portable fire detection and suppression vehicle 110 can comprise a processor 111, a memory 112, a fire suppression sub-system 113, a battery 114, a sensor 115, a transceiver 116, a global positioning receiver 117, and a camera 118.

The portable fire detection and suppression vehicle 110 can be any automated vehicle for traversing through the facility 138 and addressing an emergency condition, such as a fire. The fire suppression sub-system 113 can be any automatic fire suppression technology that controls the emergency condition (e.g., controls and extinguishes the fire). The fire suppression sub-system 113 can comprise a tank that carries fire suppression agents and a movable nozzle for effective release of the suppression agents (e.g., a rotatable gas release that increases a spread of the fire suppression agents). The portable fire detection and suppression vehicle 110 can comprise a self-cooling sub-system employing one or more cooling mechanisms to counter extreme heat conditions that prevent suppression operations by the portable fire detection and suppression vehicle.

The battery 114 can be an electric battery comprising one or more electrochemical cells with external connections provided to power the portable fire detection and suppression vehicle 110 and components thereof. For instance, the battery 114 can power the processor 111 and the memory 112.

The sensor 115 can be an electro-mechanical component that detects events or changes in an environment and outputs the events or changes as sensor signals to other components of the portable fire detection and suppression vehicle 110. In accordance with one or more embodiments, the sensor 115 can detect events or changes regarding an environment of the facility 138, such as temperatures, air pressures, light, magnetic fields, humidity, moisture, oxygen level, etc., along with an environment and position of the portable fire detection and suppression vehicle 110. For example, the sensor 115 can be a IR video sensor, a smoke sensor, and/or a heat sensor that detects a source of a fire to suppress. Further, the information gathered through the IR video sensor, the smoke sensor, and/or the heat sensor can be transmitted externally as live/real-time sensor signal feed.

The global positioning receiver 117 can be a component that operates with respect to any global navigation satellite system to acquire geolocation and time information of the portable fire detection and suppression vehicle 110. The camera 118 can be any optical instrument for capturing, transmitting, and/or recording images, videos, and/or movies.

The fire detection and suppression system 100 also comprises a control panel 130 (e.g., an area where control and/or monitoring instruments are displayed), which includes a processor 131, a memory 132, a sensor 135, and a transceiver 136. The control panel 130 can be physically located at a facility 138. The control panel 130 can include or communicate with the sensor 135 (e.g., can be linked with fire detectors) to receive/detect one or more conditions 139 of the facility 138. The facility 138 can be a residential and/or commercial structure, such as a warehouse, a high-rise, an apartment complex, a shopping mall, a concert venue, a sports venue, etc.

The fire detection and suppression system 100 also comprises a central station 140, which includes a processor 141, a memory 142, and a transceiver 146. The central station 140 can receive alarms from the control panel 130 and provide instructions to the portable fire detection and suppression vehicle 110.

Note that each item of FIG. 1 can be representative of one or more of that item such that, for example, the portable fire detection and suppression vehicle 110 can comprise one or more processors 111, one or more memories 112, one or more fire suppression sub-systems 113, one or more batteries 114, etc.

The processors 111, 131, and 141 (also referred to as a processing circuit) can be coupled via a system bus to the memories 112, 132, and 142, respectively, and various other components. The memories 112, 132, and 142 can include a read only memory (ROM) and a random access memory (RAM). The ROM is coupled to the system bus and may include a basic input/output system (BIOS), which controls certain basic functions of the fire detection and suppression system 100. The RAM is read-write memory coupled to the system bus for use by the processors 111, 131, and 141.

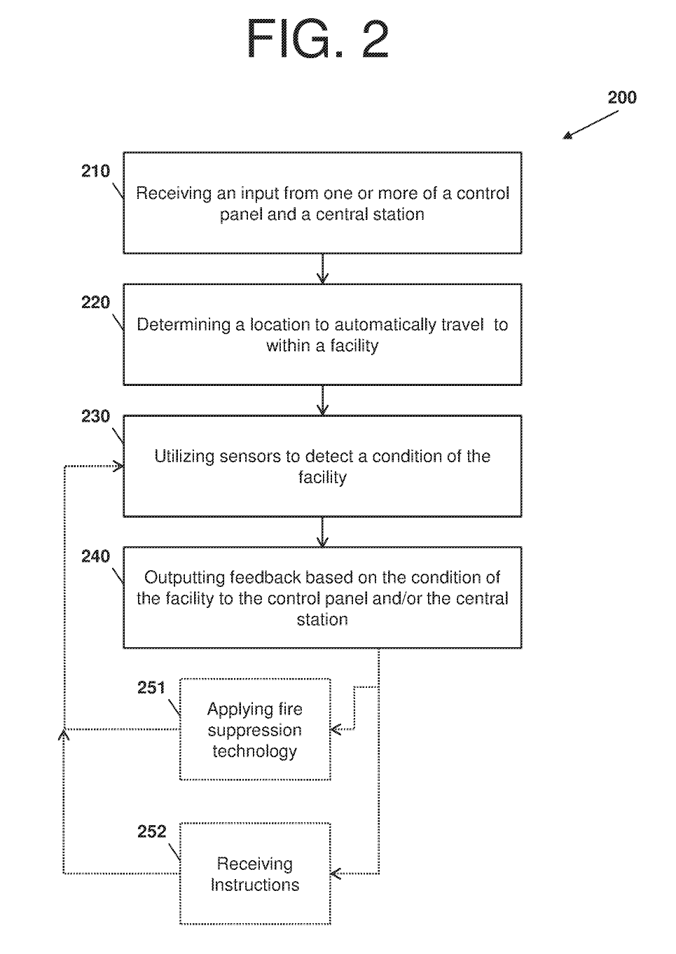

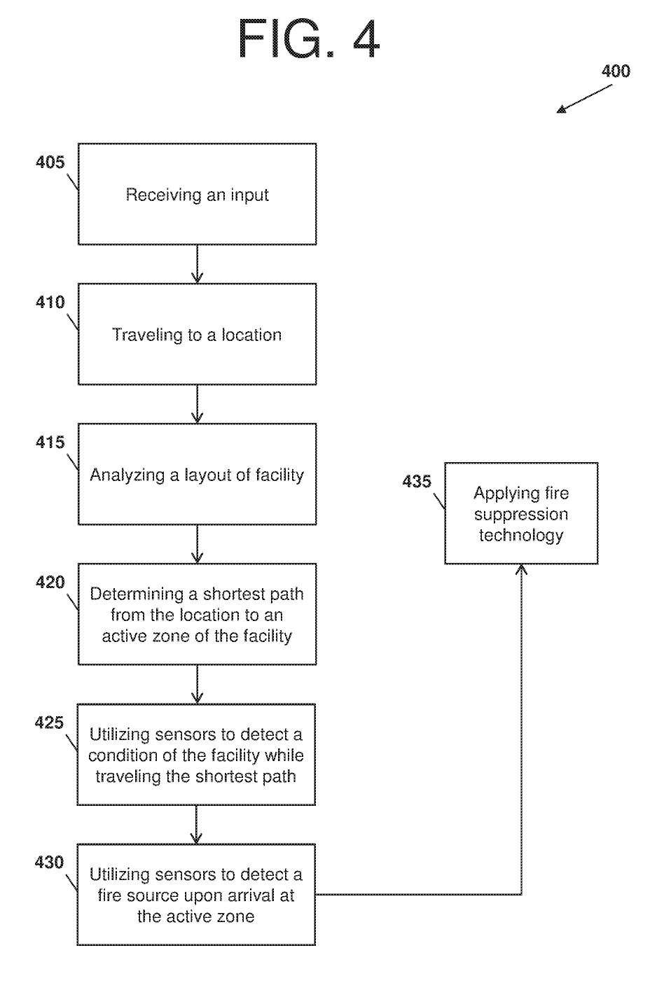

Software for execution by the fire detection and suppression system 100 may be stored in the memories 112, 132, and 142 (e.g., the memory 112 can store automatic path traversal software, fire spread software, and/or the automatic fire suppression software). The memories 112, 132, and 142 are examples of a tangible storage medium readable by the processors 111, 131, and 141, where the software is stored as instructions for execution by the processors 111, 131, and 141 to cause the fire detection and suppression system 100 to operate, such as is described herein with reference to FIGS. 2 and 4. Examples of computer program product and the execution of such instruction is discussed herein in more detail. With respect to the automatic path traversal software, the fire spread software, and/or the automatic fire suppression software, a manual override operation can be incorporated to cause the portable fire detection and suppression vehicle 110 to disengage at any desired location.

The transceivers 116, 136, and 146 can be input/output (I/O) and/or communication adapters coupled to the system bus. For example, the I/O adapter may be a small computer system interface (SCSI) adapter. The transceivers 116, 136, and 146 can communicate signals through wired or wireless connections. For instance, the control panel 130 and the central station 140 can communicate via a connection 151, the control panel 130 and the portable fire detection and suppression vehicle 110 can communicate via a connection 152, and the central station 140 and the portable fire detection and suppression vehicle 110 can communicate via a connection 153 (for instance, the portable fire detection and suppression vehicle 110 is connected to the central station 140 to receive guidance and/or fire information). The connections can be further supported by one or more networks (such as networks 155 and 156 as shown in FIG. 1). The one or more network can include, but are not limited to, IP Network, Modem, Wi-Fi, mobile communication (e.g., GSM), and the like.

FIG. 2 depicts a process flow 200 with respect to a fire detection and suppression system 100 according to one or more embodiments. The process flow 200 begins at block 210, where the portable fire detection and suppression vehicle 110 receives an input from the control panel 130 or the central station 140. The input can comprise a signal detailing an event from fire control panel and/or event from the central station 140. The input can comprise a signal detailing an event designated by authorized personnel, an event from fire detection devices within the facility 138. The input can also be a facility layout (e.g., a building map). In accordance with one or more embodiments, the input can be generated by the portable fire detection and suppression vehicle 110 via the sensor 115.

A technical effect and benefit of the portable fire detection and suppression vehicle 110 receiving the input from the central station 140 includes where an existing fire safety systems sends an alarm to the central station 140, which in turn forwards the input to the portable fire detection and suppression vehicle 110. In this way, the existing fire safety systems does not need to be altered. In addition, should the existing fire safety systems be altered to transmit the alarm to the portable fire detection and suppression vehicle 110, the portable fire detection and suppression vehicle 110 is capable of interpreting information received from the control panel 130.

At block 220, the portable fire detection and suppression vehicle 110 determines a location to automatically travel to within the facility 138. For instance, the input can identify where the emergency condition was detected within the facility 138. The portable fire detection and suppression vehicle 110 can utilize a layout of the facility 138 (e.g., data maps) that is preloaded for path traversal with respect to where the emergency condition was detected. The portable fire detection and suppression vehicle 110, in turn, automatically travels to the location of the emergency condition. Automatic travel by the portable fire detection and suppression vehicle 110 can also be implemented via the global positioning receiver 117 or, in other embodiment cases, automatic travel by the portable fire detection and suppression vehicle 110 can be overridden by manual operation.

At block 230, the portable fire detection and suppression vehicle 110 utilizes one or more sensors 115 to detect a condition of the facility 138 (e.g., an environment of the facility 138 as described herein). At block 240, the portable fire detection and suppression vehicle 110 outputs feedback based on the condition of the facility 138 to the control panel 130 and/or the central station 140. The feedback can include outputs, such as travel path to where the emergency condition was detected (e.g., a physical location of the emergency condition) and status of the suppression agent release.

Optionally, the process flow 200 can proceed to dotted block 251 and/or dotted block 252. At dotted block 251, the fire suppression sub-system 113 of the portable fire detection and suppression vehicle 110 can apply fire suppression technology. Note that the release of the suppression agent from the fire suppression sub-system 113 can includes rotating a nozzle up to 360 degrees to spread the suppression agent.

At dotted block 252, the portable fire detection and suppression vehicle 110 can receive instructions. The instructions can be received from the control panel 130 or the central station 140 in response to outputting the feedback. The instructions can further direct the portable fire detection and suppression vehicle 110 to release additional suppression agents, acquire more readings by the sensor 115, travel to another location, etc.

Note that the process flow 200 can proceed to dotted block 251 and/or dotted block 252 in accordance with predetermined settings. Predetermined setting can comprise a set of conditions that automatically cause the fire suppression sub-system 113 to apply fire suppression technology and/or receive instructions. For instance, if one or more of a position, a volume, and a temperature of a fire indicate an immediate danger of fire spreading, the fire suppression sub-system 113 can apply fire suppression technology to contain the fire. Further, the fire suppression sub-system 113 is unable to determine one or more of the position, the volume, and the temperature of a fire, the fire suppression sub-system 113 can receive instruction on how to proceed.

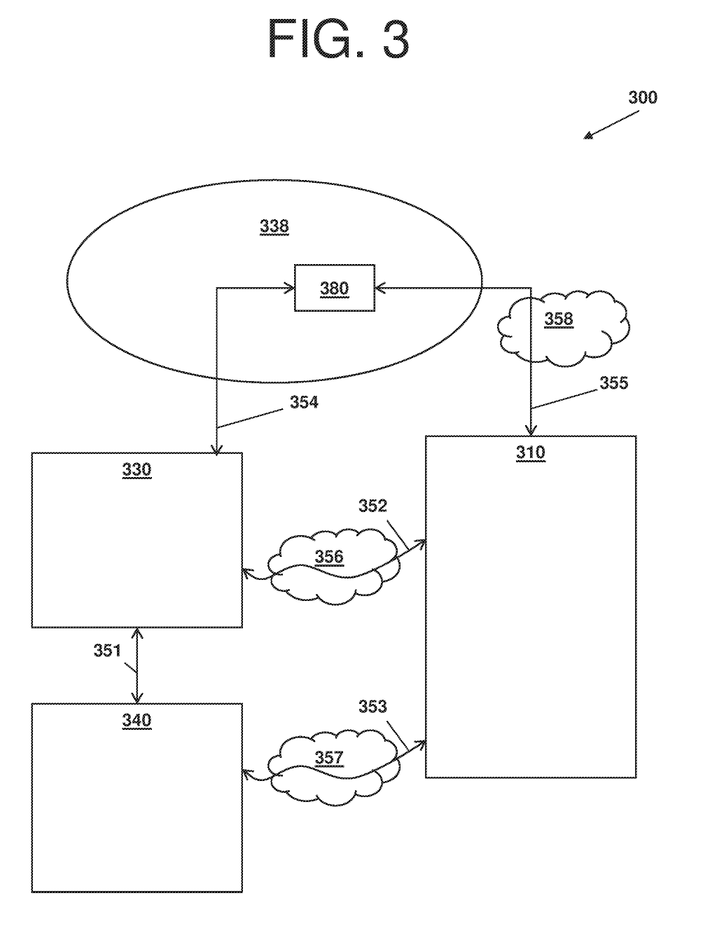

FIG. 3 depicts a fire detection and suppression system 300 comprising a portable fire detection and suppression vehicle 310 according to one or more embodiments. Components of the fire detection and suppression system 300 that are similar to components of the fire detection and suppression system 100 are reused for ease of explanation and are be reintroduced. The fire detection and suppression system 300 also comprises a control panel 330, which can be physically located at a facility 338, and a central station 340.

The portable fire detection and suppression vehicle 310, the control panel 330, and the central station 340 can communicate via signals through wired or wireless connections, such as connections 351, 352, 353, 354, and 355. The connections 351, 352, 353, 354, and 355 can be further supported by one or more networks (such as networks 356, 357, and 358 as shown in FIG. 3). Thus, the portable fire detection and suppression vehicle 310 and the control panel 330 can include or communicate with the sensor 380 (e.g., can be linked with fire detectors) to receive/detect an active zone of the facility 338.

Note that each item of FIG. 3 can be representative of one or more of that item and can include additional components such that, for example, the portable fire detection and suppression vehicle 310 can comprise one or more processors, one or more memories, one or more fire suppression sub-systems, one or more batteries, etc.

FIG. 4 depicts a process flow 400 with respect to a fire detection and suppression system 300 according to one or more embodiments. The process flow 400 begins at block 405, where the portable fire detection and suppression vehicle 310 receives an input. The input can include an event type, contact identification, an event state, an address, etc. According to one or more embodiments, the input can be received directly from the sensor 380.

At block 410, the portable fire detection and suppression vehicle 310 travels to a location. The location can be an address of the facility 338. The portable fire detection and suppression vehicle 310 can further travel to an access point of the facility 338, such as a door, a window, a loading dock, etc. At block 415, the portable fire detection and suppression vehicle 310 analyzes a layout of the facility 338. The analysis can be in conjunction with the travel to the location. At block 420, the portable fire detection and suppression vehicle 310 determines a shortest path from the location to an active zone of the facility 338. For instance, based on a current location of the portable fire detection and suppression vehicle 310, the portable fire detection and suppression vehicle 310 identifies the shortest path using automatic path traversal software to reach the active zone.

At block 425, the portable fire detection and suppression vehicle 310 utilizes sensors to detect a condition of the facility while traveling the shortest path. Note that the portable fire detection and suppression vehicle 310 can provide a real-time/live feed to the central station 340.

At block 430, the portable fire detection and suppression vehicle 310 utilizes sensors to detect a fire source upon arrival at the active zone. For instance, once vehicle reaches the active zone, the portable fire detection and suppression vehicle 310 confirms the fire source using fire spread software, and/or the automatic fire suppression software.

At block 435, the portable fire detection and suppression vehicle 310 applies fire suppression technology. For instance, once the fire source and a direction are identified, the suppression agents are release in the direction.

Note that a termination of the suppression process can be determined by a state of the sensors of the portable fire detection and suppression vehicle 310. The area covered by the suppression agents (once the vehicle reached active zone) can be configurable and inputs from authorized personnel can override the direction of suppression. When multiple events or emergency conditions are received by the portable fire detection and suppression vehicle 310, the multiple events or emergency conditions can be served in order of priority (e.g., most dangerous or volatile to least). When multiple events or emergency conditions of same priority are received, multiple events or emergency conditions can be served based on first come first serve basis.

Technical effects and benefits of embodiments herein can include enhanced fire detection techniques to handle false alarms and also identify areas of rapid fire spreads and take actions; efficient fire suppression techniques for increased life safety and also reduced risk for fire fighters; and effective utilization of releasing agent and suppression elements, avoiding wastage and release at undesired locations. Thus, embodiments herein can be used to protect from fire calamities in warehouses, saving property and inventory; to create meta data with respect to heat maps, smoke maps, percentage of oxygen, safe area, etc.; and to provide real-time/live feeds from the portable fire detection and suppression vehicle to identify possible life threats and smoke spread, saving human life.

Embodiments herein can include a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the embodiments herein.

Aspects of the embodiments herein are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Aspects of the embodiments are described herein with reference to flowchart illustrations, schematics, and/or block diagrams of methods, apparatus, and/or systems according to embodiments. Further, the descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the spirit of embodiments herein. For instance, the steps may be performed in a differing order or steps may be added, deleted or modified. All of these variations are considered a part of the claims.

While the preferred embodiment has been described, it will be understood that those skilled in the art, both now and in the future, may make various improvements and enhancements which fall within the scope of the claims which follow. These claims should be construed to maintain the proper protection.

What is claimed is:

1. A portable fire detection and suppression vehicle comprising:
a fire suppression sub-system; and
one or more sensors,
wherein the portable fire detection and suppression vehicle receives an input from a control panel of a facility or a central station, determines a location to automatically travel to within the facility, utilizes the one or more sensors to detect a condition of the facility, and outputs feedback based on the condition to the control panel or the central station.

2. The portable fire detection and suppression vehicle of claim 1, wherein the fire suppression sub-system is utilized to suppress a fire within the facility upon arrival by the portable fire detection and suppression vehicle at the location.

3. The portable fire detection and suppression vehicle of claim 1, wherein the portable fire detection and suppression vehicle receives instructions from the control panel or the central station in response to outputting the feedback.

4. The portable fire detection and suppression vehicle of claim 1, wherein the portable fire detection and suppression vehicle travels to an access point of the facility in response to the input.

5. The portable fire detection and suppression vehicle of claim 4, wherein the location is an active zone within the facility, and
wherein the portable fire detection and suppression vehicle analyzes a layout of facility and determines shortest path from the access point to the active zone.

6. The portable fire detection and suppression vehicle of claim 5, wherein the portable fire detection and suppression vehicle utilizes the one or more sensors to detect a fire source upon arrival at the active zone.

7. The portable fire detection and suppression vehicle of claim 1, wherein the portable fire detection and suppression vehicle utilizes processes inputs received from one or more facility sensors within the facility.

8. The portable fire detection and suppression vehicle of claim 1, wherein the portable fire detection and suppression vehicle utilizes comprises algorithms to dynamically prioritize multiple events at the facility, and
wherein the portable fire detection and suppression attends to each of the multiple events based on the dynamic prioritization.

9. The portable fire detection and suppression vehicle of claim 1, wherein the portable fire detection and suppression vehicle comprises a self-cooling sub-system employing one or more cooling mechanisms to counter extreme heat conditions that prevent suppression operations by the portable fire detection and suppression vehicle.

10. A fire detection and suppression system comprising:
a portable fire detection and suppression vehicle comprising:
a fire suppression sub-system; and
one or more sensors; and
a control panel of a facility or a central station,
wherein the portable fire detection and suppression vehicle receives an input from the control panel or the central station, determines a location to automatically travel to within the facility, utilizes the one or more sensors to detect a condition of the facility, and outputs feedback based on the condition to the control panel or the central station.

11. The fire detection and suppression system of claim 8, wherein the fire suppression sub-system is utilized to suppress a fire within the facility upon arrival by the portable fire detection and suppression vehicle at the location.

12. The fire detection and suppression system of claim 8, wherein the portable fire detection and suppression vehicle receives instructions from the control panel or the central station in response to outputting the feedback.

13. The fire detection and suppression system of claim 8, wherein the portable fire detection and suppression vehicle travels to an access point of the facility in response to the input.

14. The fire detection and suppression system of claim 11, wherein the location is an active zone within the facility, and
wherein the portable fire detection and suppression vehicle analyzes a layout of facility and determines shortest path from the access point to the active zone.

15. The fire detection and suppression system of claim 12, wherein the portable fire detection and suppression vehicle utilizes the one or more sensors to detect a fire source upon arrival at the active zone.

16. The fire detection and suppression system of claim 8, wherein the portable fire detection and suppression vehicle utilizes processes inputs received from one or more facility sensors within the facility.

17. The fire detection and suppression system of claim 8, wherein the portable fire detection and suppression vehicle utilizes comprises algorithms to dynamically prioritize multiple events at the facility, and
wherein the portable fire detection and suppression attends to each of the multiple events based on the dynamic prioritization.

18. The fire detection and suppression system of claim 8, wherein the portable fire detection and suppression vehicle comprises a self-cooling sub-system employing one or more cooling mechanisms to counter extreme heat conditions that prevent suppression operations by the portable fire detection and suppression vehicle.
